(19) United States
(12) Patent Application Publication
(10) Pub. No.: US 2014/0064742 A1
(43) Pub. Date: Mar. 6, 2014

(54) EVENT SYNCHRONIZATION FOR OPTICAL SIGNALS

(71) Applicants: David A. BARFOOT, Houston, TX (US); Henry C. BLAND, Calgary (CA); John L. MAIDA, JR., Houston, TX (US)

(72) Inventors: David A. BARFOOT, Houston, TX (US); Henry C. BLAND, Calgary (CA); John L. MAIDA, JR., Houston, TX (US)

(73) Assignee: HALLIBURTON ENERGY SERVICES, INC., Houston, TX (US)

(21) Appl. No.: 13/598,491

(22) Filed: Aug. 29, 2012

(51) Int. Cl. H04B 10/00

(52) U.S. Cl. 398/154

(57) ABSTRACT

A system for synchronizing an optical signal with an initiation of an event can include an event controller which controls the initiation of the event, and an optical modulator which modulates the optical signal in response to receipt of an indication from the event controller that the event is initiated. A method of synchronizing an optical signal with an initiation of an event can include transmitting from an event controller an indication that the event is initiated, receiving the indication that the event is initiated, and modulating the optical signal in response to the receiving. A system for synchronizing multiple optical signals can include at least one time-code generator which generates time-codes, and multiple optical modulators which modulate the respective optical signals in response to generation of the time-codes by the at least one time-code generator.

### BACKGROUND

This disclosure relates generally to equipment utilized and operations performed in conjunction with subterranean wells and, in an example described below, more particularly provides event synchronization for optical signals.

Sensor response signals can be transmitted via optical waveguides, such as optical fibers. For example, in seismological investigations, measurements taken by seismic sensors in response to vibration generated by a seismic source can be transmitted via optical fiber to a recorder for storage, display, analysis, etc.

It would be advantageous to be able to reliably, conveniently and economically synchronize the optically transmitted sensor measurements with the generation of the vibration by the seismic source. More generally, it would be advantageous to be able to synchronize optically transmitted signals with any event (for example, stimulation fluid flow, fracture initiation, production fluid flow, seismic events, etc.), and/or to synchronize optically transmitted signals with each other.

### SUMMARY

In the disclosure below, systems and methods are provided which bring improvements to the art of optical signal synchronization. One example is described below in which optical signals are modulated in response to generation of vibration by a seismic source. Another example is described below in which initiation of an event causes an optically transmitted signal to be modulated in synchronization with the initiation of the event. In other examples, optical signals can be synchronized by modulating time-code information on the signals.

A system for synchronizing at least one optical signal with an initiation of an event is provided to the art by the disclosure below. In one example, the system can comprise an event controller which controls the initiation of the event, and at least one optical modulator which modulates the optical signal in response to receipt of an indication from the event controller that the event is initiated.

A method of synchronizing at least one optical signal with an initiation of an event is also described below. In one example, the method can include transmitting from an event controller to an optional optical modulator controller an indication that the event is initiated. The optical signal is modulated in response to receipt of the indication that the event is initiated.

Another system described below for synchronizing at least one optical signal with an initiation of a seismic event can comprise a controller which controls initiation of vibration from a seismic source, and at least one optical modulator which modulates the optical signal in response to operation of the seismic source by the controller.

A system for synchronizing multiple optical signals is also described below. In one example, the system can include at least one time-code generator which generates time-codes, and multiple optical modulators which modulate the respective optical signals in response to generation of the time-codes by the at least one time-code generator.

A method of synchronizing multiple optical signals described below can comprise: providing communication between at least one time-code generator which generates time-codes and multiple optical modulators; and the optical modulators modulating the respective optical signals in response to generation of the time-codes by the at least one time-code generator.

These and other features, advantages and benefits will become apparent to one of ordinary skill in the art upon careful consideration of the detailed description of representative examples below and the accompanying drawings, in which similar elements are indicated in the various figures using the same reference numbers.

### BRIEF DESCRIPTION OF THE DRAWINGS

FIG. 1 is a representative partially cross-sectional view of a system and associated method which can embody principles of this disclosure.

FIG. 2 is a representative partially cross-sectional view of another example of the system.

FIGS. 3-6 are schematic views of further examples of the system.

### DETAILED DESCRIPTION

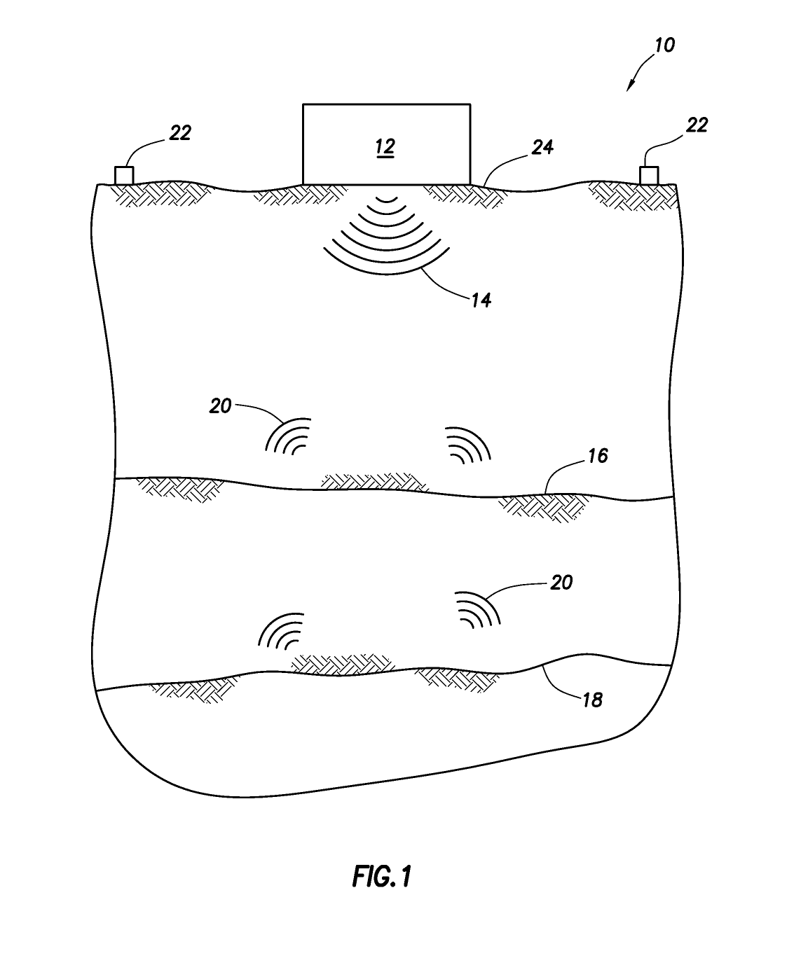

Representatively illustrated in FIG. 1 is a system 10 and associated method which can embody principles of this disclosure. However, it should be clearly understood that the system 10 and method are merely one example of an application of the principles of this disclosure in practice, and a wide variety of other examples are possible. Therefore, the scope of this disclosure is not limited at all to the details of the system 10 and method described herein and/or depicted in the drawings.

In the FIG. 1 example, a seismic source 12 is used to generate vibration 14 in the earth. The vibration 14 is reflected, e.g., at boundaries 16, 18 between earth strata.

The seismic source 12 may be any source capable of propagating the vibrations 14 through the earth. For example, a “thumper” truck or Vibroseis truck, an explosive device, an air gun, a perforating gun, a subterranean fracture propagation, or any other source of vibration of the earth may be used.

Reflected vibrations 20 are detected by seismic sensors 22. The seismic sensors 22 may be any type of sensors capable of measuring characteristic parameters of the reflected vibrations 20. For example, the sensors 22 could be geophones, accelerometers, seismometers, an optical distributed acoustic sensor, an optical distributed vibration sensor, etc. Suitable optical distributed acoustic and vibration sensors are described in US publication nos. 2011/0088462 and 2012/0014211, but other types of sensors may be used if desired.

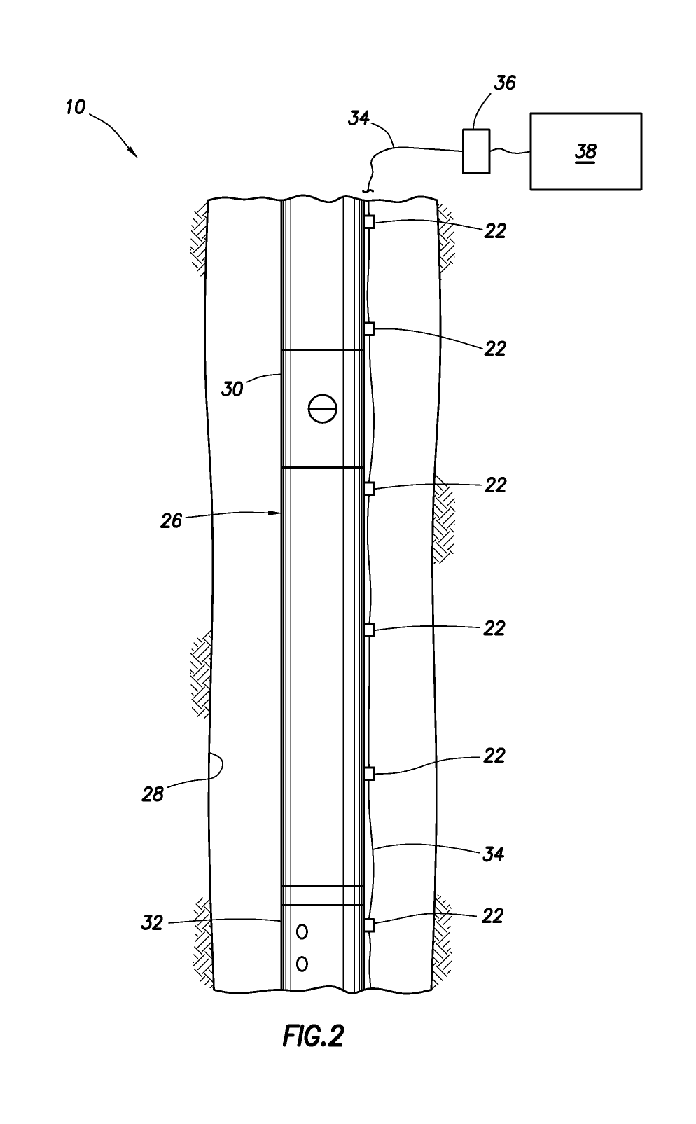

Although the seismic source 12 and the sensors 22 are depicted in FIG. 1 as being located at the earth's surface 24, the source and sensors may be positioned as desired for a particular operation. For example, if one or more wellbores (not shown in FIG. 1, see FIG. 2) are present, the source 12 and/or sensors 22 could be positioned in the wellbores. In some examples, the source 12 could be positioned at the surface 24, and the sensors 22 could be positioned in the wellbore(s). In other examples, the source 12 could be subterranean (but not necessarily in a wellbore), and the sensors 22 could be positioned at the surface 24. Thus, any positioning of the source 12 and sensors 22 may be used, within the scope of this disclosure.

It will be appreciated by those skilled in the art that the reflected vibrations 20 will arrive at the sensors 22 at different times. The arrival times can vary, depending on the velocity of sound in the different earth strata, relative locations and orientations of the source 12, sensors 22, and strata boundaries 16, 18, etc. Thus, it can be difficult to synchronize measurements taken by a sensor 22 with the initial propagation of the vibration 14, and/or to synchronize measurements taken by one sensor with measurements taken by another sensor, so that useful information can be derived from the measurements.

However, in the system 10 example as described more fully below, the measurements taken by the sensors 22 are transmitted as optical signals via one or more optical waveguides. The optical signals are synchronized with initiation of an event (such as, a seismic event generated by the seismic source 12, etc.), and/or with other optical signals, by modulating the optical signals in response to the event being initiated, or by modulating the optical signals with a synchronized time signal.

Any type of event can be initiated. For example, a valve or other type of flow control device could be opened, closed or choked, thereby generating an acoustic signal, which is detected by a distributed acoustic sensor. As another example, a perforating gun or other type of explosive device could be detonated in a wellbore, thereby generating vibration as a seismic source. As yet another example, a pump could inject fluid into a subterranean formation, causing the formation to fracture, in which case initiation of the injection fluid flow and/or the fracturing could be detected by sensors (such as geophones, hydrophones, accelerometers, seismometers, distributed acoustic sensors, distributed vibration sensors, tiltmeters, etc.).

Referring additionally now to FIG. 2, another example of the system 10 and method is representatively illustrated. In this example, the sensors 22 are longitudinally distributed along a tubular string 26 (such as, a completion, production or stimulation string, etc.) installed in a wellbore 28. Although the sensors 22 are depicted as being external to the tubular string 26, in other examples the sensors could be positioned internal to, or in a wall of, the tubular string.

The wellbore 28 is depicted as being uncased or open hole, but in other examples the wellbore could be lined with liner, casing, cement, etc. The sensors 22 could be positioned internal to, external to, or in a wall of any such liner, casing, cement, etc.

The tubular string 26 is depicted as having a valve, choke, or other type of flow control device 30 interconnected in the tubular string. Also included in the tubular string 26 is a perforating gun, explosive charge, or other type of explosive device 32. As mentioned above, the flow control device 30 and/or explosive device 32 may be used as sources of vibration 14 (such as acoustic vibration, etc.), which may be measured using sensors 22 to detect the vibration and/or its reflections. Of course, the sensors 22 can also, or alternatively, be used to detect seismic signals generated by the seismic source 12 (as in the FIG. 1 example).

Preferably, the sensors 22 are connected to an optical waveguide 34 (such as, an optical fiber or ribbon, etc.) for transmission of optical signals indicative of characteristics of the vibration. The sensors 22 are not necessarily optical sensors, but preferably the sensor measurements are transmitted as optical signals via the optical waveguide 34.

In some cases, the optical waveguide 34 and the sensors 22 can be a same element. For example, in the cases of distributed temperature, acoustic, vibration and strain sensing, the optical waveguide 34 is itself the sensor, in that temperatures, vibrations, strains, and/or densities, etc. of the optical waveguide are detected as indications of parameters of interest. Various types of optical backscatter in the waveguide 34 (e.g., Raman, Rayleigh (coherent or not), Brillouin (stimulated or not), etc.) may be detected, recorded and analyzed as indications of temperature, acoustic vibration, strain, etc., distributed along the waveguide. Such techniques are well known to those skilled in the art (e.g., as disclosed in the publications mentioned above, etc.), and so those techniques are not further described here. Any techniques in which an optical waveguide comprises a sensor may be used, within the scope of this disclosure.

The optical signals transmitted via the waveguide 34 are modulated by an optical modulator 36, so that the optical signals can be synchronized with initiation of an event, or with a same time signal. The modulated optical signals are then received by an optical device 38 (such as, an interrogator, a recorder and/or a signal conditioning/analysis/display apparatus, etc.).

The optical modulator 36 can modulate the optical signals in any of a variety of different ways. For example, the modulator 36 may vary an optical path length via which the optical signals are transmitted, the modulator may variably attenuate the optical signals, the modulator may vary a phase of the optical signals, etc. Any manner of modulating the optical signals may be used, within the scope of this disclosure.

In one example, the modulator 36 could comprise a length of optical fiber wrapped about a piezoelectric material (such as, lead zirconate titanate (PZT), etc.). An electrical field applied to the piezoelectric material will cause the material to change shape, thereby stretching or elongating the optical fiber. This will increase an optical path length of the optical fiber, thereby changing a phase of the optical signals transmitted via the optical path.

In another example, the modulator 36 could comprise a variable optical attenuator (VOA) connected in series with the waveguide 34. In this manner, the optical signals can be more or less attenuated in response to initiation of an event (such as, operation of the flow control device 30 or any other type of well tool, detonation of the explosive device 32, generation of vibration 14 by the seismic source 12, etc.).

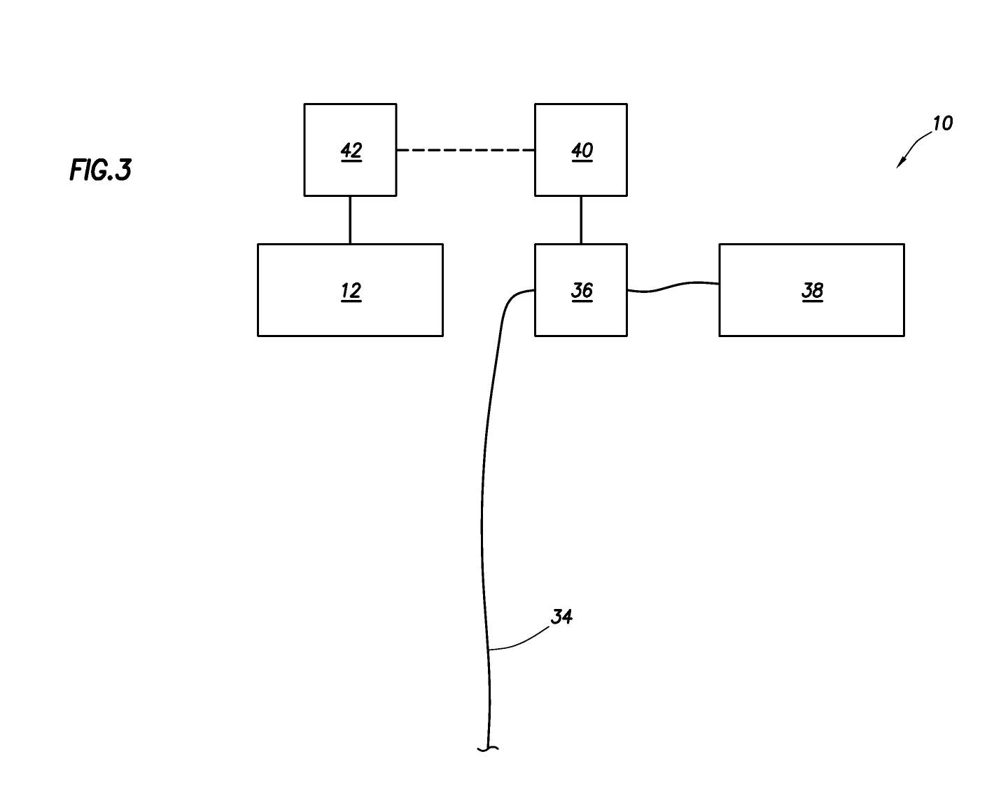

Referring additionally now to FIG. 3, another example of the system 10 is depicted apart from the wellbore 28. The system 10 may be used, in keeping with the scope of this disclosure, whether or not any component of the system is in, on or proximate any wellbore.

In the FIG. 3 example, an optical modulator controller 40 is used to control operation of the modulator 36. For example, if the modulator 36 is operated by varying an electrical field applied to a piezoelectric material, the controller 40 may control a supply of electrical power to the modulator. The controller 40 could be combined with the modulator 36 and/or device 38.

The controller 40 is in communication with another event controller 42, which controls initiation of an event. In the FIG. 3 example, the controller 42 controls operation of the seismic source 12. For example, the controller 42 could operate an air gun, an explosive device, a flow control device, a Vibroseis vibratory source, a “thumper” truck weight drop, etc.

However, it should be understood that events other than seismic events (e.g., fluid flows, temperature changes, etc.) can be controlled by the controller 42. Any type of event can be controlled by the controller 42, within the scope of this disclosure.

The controllers 40, 42 can be in communication by any means. For example, wired or wireless communication may be used.

Preferably, the controller 42 communicates an indication that the event is initiated to the controller 40. The indication can be communicated by modulating, initiating or ceasing transmission of any type of wired or wireless signal. For example, when the controller 42 operates the seismic source 12 to transmit the vibration 14, this can also be communicated from the controller 42 to the controller 40, so that the optical signals can be appropriately modulated.

This modulation of the optical signals when the event is initiated allows the optical signals to be conveniently synchronized with the initiation of the event. In practice, the point in time at which the optical signals were modulated (as clearly observable in the recorded signals) can correspond directly to the point in time at which the event was initiated. In other examples, calibrations, delay time corrections, etc., may be applied to account for various factors (such as, sensor positioning, velocity models, etc.) in the synchronizing process.

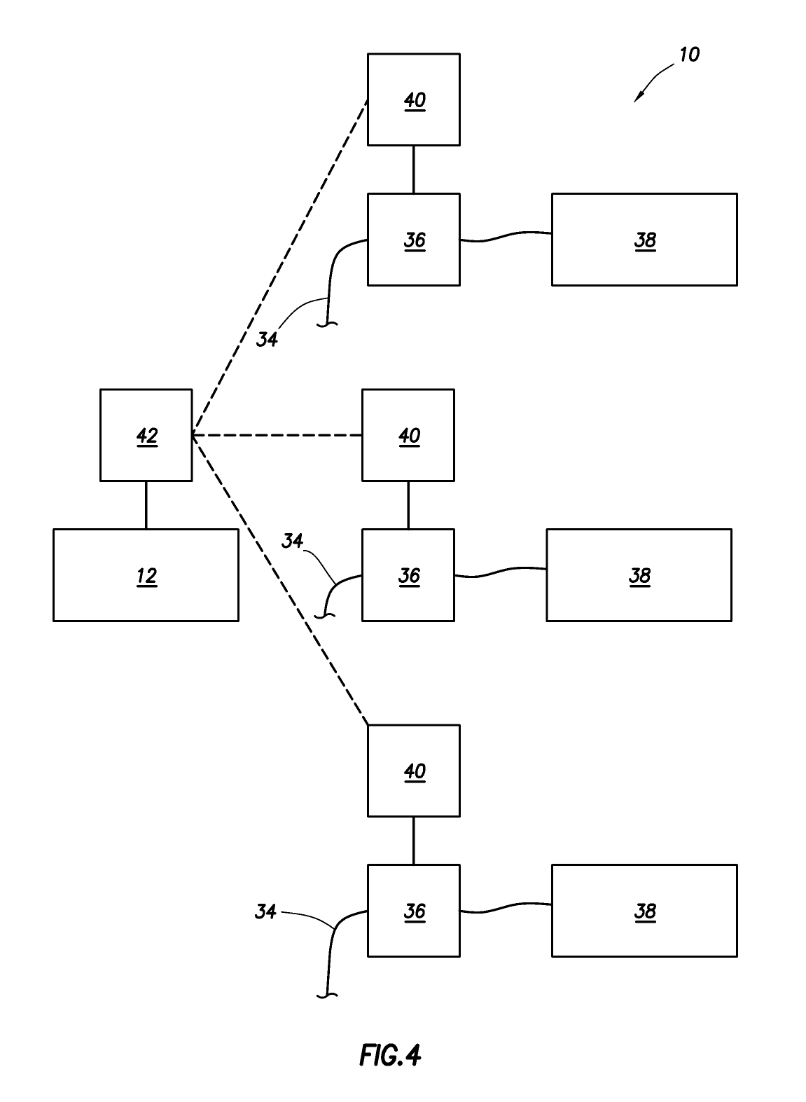

In the FIG. 3 example, only one optical waveguide 34 is depicted as transmitting the optical signals. In other examples, such as that representatively illustrated in FIG. 4, multiple waveguides 34 may be used as sensors, or to transmit optical signals with indications of measurements taken by separate sensors 22 connected to the waveguides.

Multiple optical modulators 36 are used to modulate the optical signals transmitted via the respective waveguides 34. Although multiple optical interrogating/recording/analysis/display devices 38 are depicted in FIG. 4, a single device could transmit/receive optical signals with multiple waveguides 34.

Multiple controllers 40 control operation of the respective modulators 36. Each of the controllers 40 is in communication with the event controller 42 so that, when the event is initiated, an indication of the initiation is communicated to each of the controllers 40. In this manner, the optical signals transmitted by all of the waveguides 34 can be simultaneously modulated by the modulators 36, and synchronization of the signals can thereby be conveniently accomplished.

Although the event controller 42 and the modulator controller(s) 40 are depicted as separate components in FIGS. 3 & 4, it will be appreciated that these components could be combined, and/or could be combined with any other component(s) of the system 10. The scope of this disclosure is not limited to any particular configuration or combination of components depicted in the drawings or described herein.

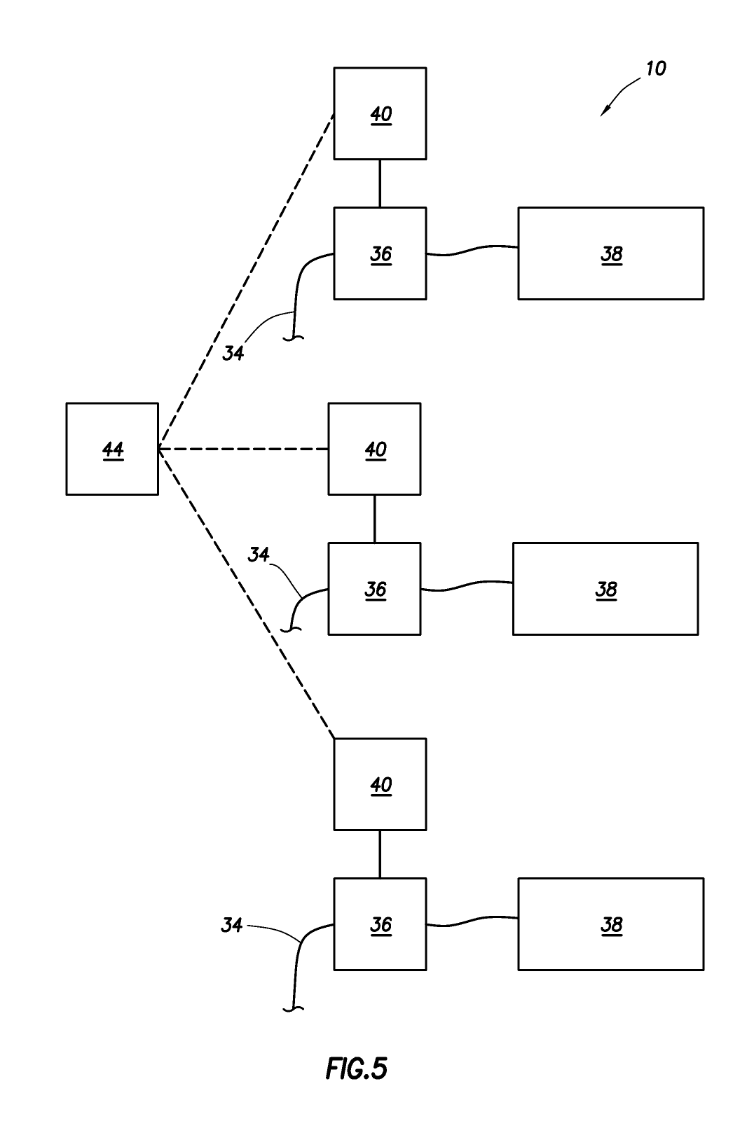

Referring additionally now to FIG. 5, another example of the system 10 is representatively illustrated. In this example, the modulator controllers 40 are not in communication with the event controller 42, but are instead in communication with a time-code generator, such as a GPS (Global Positioning System) receiver 44. In this manner, the optical signals transmitted via the optical waveguides 34 can be synchronously modulated with time signals derived from the GPS receiver 44.

For example, for continuous measurements whereby an event may not be planned in advance, but time synchronization of measurement data is important, a time-code signal can be encoded into the optical sensing data using one of many possible formats. Global Positioning System time-code generators are commercially available that output an electrical time-code waveform containing a GPS synchronized time (received from one or more GPS satellites). Such a time-code generator could be integrated with the receiver 44 depicted in FIG. 5, if desired.

The electrical output of a GPS time-code generator could be used by the modulators 36 to modulate the optical signals transmitted via the optical waveguides 34, based on an encoding method, such as, SMPTE linear time codes used in audio applications. When multiple monitoring systems are deployed within a study region, the resulting synchronization will allow for unified processing of seismic wave fields recorded on these systems. Unified processing would result in improved source-location accuracy, as well as increased system sensitivity.

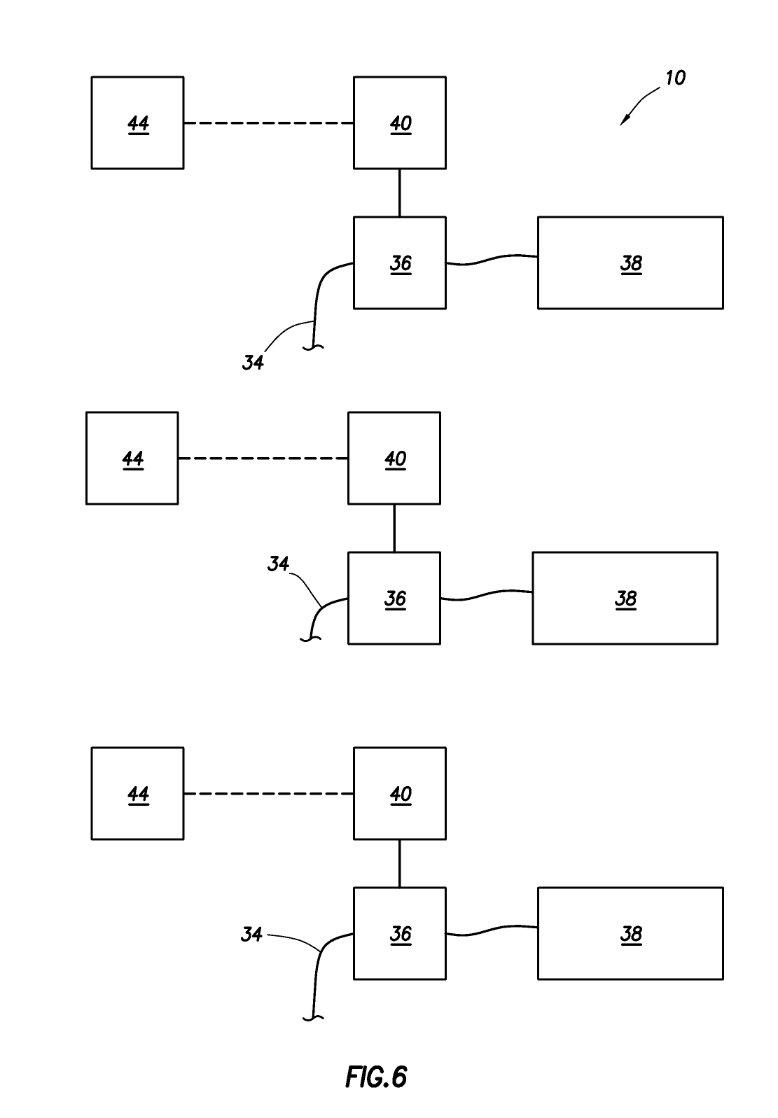

Referring additionally now to FIG. 6, another example of the system 10 is representatively illustrated. In this example, multiple GPS receivers 44 are used, with each modulator controller 40 being in communication with a respective GPS receiver. In some examples, the modulator controllers 40 could each have a GPS receiver incorporated therewith.

One advantage of using multiple GPS receivers 44 is that unique location information can also (in addition to synchronized time information) be modulated on the optical signals transmitted via the optical waveguides 34. In this manner, the locations of each of the optical waveguides 34 can be recorded, along with the sensor 22 outputs and the synchronized time-code information.

Note that, although not shown in FIGS. 5 & 6, a GPS receiver 44 could also be in communication with the event controller 42, so that the initiation of the event can also be synchronized with the recorded sensor 22 outputs. This can be useful in situations where the event is initiated (e.g., using the controller 42, etc.), whether planned in advance or unplanned.

Instead of the GPS receiver 44, other sources of time-code signals may be used. For example, a suitably precise crystal oscillator, an atomic clock, etc. The scope of this disclosure is not limited to use of any particular type of clock or other source of a time-code signal.

It may now be fully appreciated that this disclosure provides significant advancements to the art of synchronizing optical signals. In some examples described above, initiating operation of a seismic source 12 to generate vibration 14 can cause an optical signal to be modulated, thereby allowing for convenient and economical synchronizing of the optical signal with the initiation of the vibration. In other examples, optical signals can be synchronized by modulating time-code information on the signals.

A system 10 for synchronizing at least one optical signal with an initiation of an event is described above. In one example, the system 10 can include an event controller 42 which controls the initiation of the event, and at least one optical modulator 36 which modulates the optical signal in response to receipt of an indication from the event controller 42 that the event is initiated.

The event controller 42 may control operation of a seismic source 12, a flow control device 30, an explosive device 32, or any type of well tool.

The optical modulator 36 may modulate an optical path length, variably attenuate the optical signal, and/or vary a phase of the optical signal.

The system 10 can include a modulator controller 40 which controls operation of the modulator 36. The indication may be transmitted from the event controller 42 to the modulator controller 40.

The system 10 can include an optical waveguide 34 which transmits the optical signal at least partially to the modulator 36. The optical waveguide 34 may comprise an optical sensor which senses vibration, temperature change or another parameter due to the initiation of the event.

The optical waveguide 34 may be connected to multiple sensors 22 which sense at least one parameter characteristic of the event. The event controller 42 may control operation of a seismic source 12, and the optical waveguide 34 may sense vibration generated by the seismic source 12.

Multiple optical signals can be modulated by respective multiple optical modulators 36 in response to the indication from the event controller 42 that the event is initiated.

A method of synchronizing at least one optical signal with an initiation of an event is also described above. In one example, the method can include transmitting from an event controller 42 to an optical modulator controller 40 an indication that the event is initiated, receiving the indication that the event is initiated, and modulating the optical signal in response to the receiving.

Another system 10 example for synchronizing at least one optical signal with an initiation of a seismic event can comprise a controller 42 which controls initiation of vibration 14 from a seismic source 12, and at least one optical modulator 36 which modulates the optical signal in response to operation of the seismic source 12 by the controller 42.

The seismic source 12 may comprise an explosive device 32, an earth vibrator (e.g., a thumper or Vibroseis truck, etc.), a fracture, or another type of seismic source.

A system 10 for synchronizing multiple optical signals is also described below. In one example, the system 10 can include at least one time-code generator (such as GPS receiver 44) which generates time-codes, and multiple optical modulators 36 which modulate the respective optical signals in response to generation of the time-codes by the at least one time-code generator.

The time-code generator may comprise a Global Positioning System receiver 44. The optical modulators 36 can modulate the respective optical signals in response to generation of location information by the Global Positioning System receiver 44.

The at least one time-code generator may comprise multiple time-code generators, and the optical modulators 36 may modulate the respective optical signals in response to generation of the time-codes by respective ones of the time-code generators. The multiple time-code generators may comprise multiple Global Positioning System receivers 44, and the optical modulators 36 may modulate the respective optical signals in response to generation of respective location information by the respective Global Positioning System receivers 44.

The system 10 can include a controller 42 which controls initiation of vibration from a seismic source 12, and the controller 42 may be in communication with the at least one time-code generator.

The system 10 can include multiple optical waveguides 34 which transmit the respective optical signals at least partially to the respective modulators 36. The optical waveguides 34 can comprise optical sensors which sense vibration due to operation of a seismic source 12. The optical waveguides 34 may be connected to multiple sensors 22 which sense at least one parameter characteristic of a seismic event.

Also described above is a method of synchronizing multiple optical signals. In one example, the method can include: providing communication between multiple optical modulators 36 and at least one time-code generator (such as a GPS receiver 44, a crystal oscillator, an atomic clock, or another type of clock) which generates time-codes; and the optical modulators 36 modulating the respective optical signals in response to generation of the time-codes by the at least one time-code generator.

Although various examples have been described above, with each example having certain features, it should be understood that it is not necessary for a particular feature of one example to be used exclusively with that example. Instead, any of the features described above and/or depicted in the drawings can be combined with any of the examples, in addition to or in substitution for any of the other features of those examples. One example's features are not mutually exclusive to another example's features. Instead, the scope of this disclosure encompasses any combination of any of the features.

Although each example described above includes a certain combination of features, it should be understood that it is not necessary for all features of an example to be used. Instead, any of the features described above can be used, without any other particular feature or features also being used.

It should be understood that the various embodiments described herein may be utilized in various orientations, such as inclined, inverted, horizontal, vertical, etc., and in various configurations, without departing from the principles of this disclosure. The embodiments are described merely as examples of useful applications of the principles of the disclosure, which is not limited to any specific details of these embodiments.

In the above description of the representative examples, directional terms (such as “above,” “below,” “upper,” “lower,” etc.) are used for convenience in referring to the accompanying drawings. However, it should be clearly understood that the scope of this disclosure is not limited to any particular directions described herein.

The terms “including,” “includes,” “comprising,” “comprises,” and similar terms are used in a non-limiting sense in this specification. For example, if a system, method, apparatus, device, etc., is described as “including” a certain feature or element, the system, method, apparatus, device, etc., can include that feature or element, and can also include other features or elements. Similarly, the term “comprises” is considered to mean “comprises, but is not limited to.”

Of course, a person skilled in the art would, upon a careful consideration of the above description of representative embodiments of the disclosure, readily appreciate that many modifications, additions, substitutions, deletions, and other changes may be made to the specific embodiments, and such changes are contemplated by the principles of this disclosure. For example, structures disclosed as being separately formed can, in other examples, be integrally formed and vice versa. Accordingly, the foregoing detailed description is to be clearly understood as being given by way of illustration and example only, the spirit and scope of the invention being limited solely by the appended claims and their equivalents.

What is claimed is:

1. A system for synchronizing at least one optical signal with an initiation of an event, the system comprising:
an event controller which controls the initiation of the event; and
at least one optical modulator which modulates the optical signal in response to receipt of an indication from the event controller that the event is initiated.

2. The system of claim 1, wherein the event controller controls operation of a seismic source.

3. The system of claim 1, wherein the event controller controls operation of a flow control device.

4. The system of claim 1, wherein the event controller controls operation of an explosive device.

5. The system of claim 1, wherein the optical modulator modulates an optical path length.

6. The system of claim 1, wherein the optical modulator variably attenuates the optical signal.

7. The system of claim 1, wherein the optical modulator varies a phase of the optical signal.

8. The system of claim 1, further comprising a modulator controller which controls operation of the modulator.

9. The system of claim 8, wherein the indication is transmitted from the event controller to the modulator controller.

10. The system of claim 1, further comprising an optical waveguide which transmits the optical signal at least partially to the modulator.

11. The system of claim 10, wherein the optical waveguide comprises an optical sensor which senses vibration due to the initiation of the event.

12. The system of claim 10, wherein the optical waveguide comprises an optical sensor which senses temperature change due to the initiation of the event.

13. The system of claim 10, wherein the optical waveguide is connected to multiple sensors which sense at least one parameter characteristic of the event.

14. The system of claim 10, wherein the event controller controls operation of a seismic source, and wherein the optical waveguide senses vibration generated by the seismic source.

15. The system of claim 1, wherein multiple optical signals are modulated by respective multiple optical modulators in response to the indication from the event controller that the event is initiated.

16. A method of synchronizing at least one optical signal with an initiation of an event, the system comprising:
transmitting from an event controller an indication that the event is initiated;
receiving the indication that the event is initiated; and
modulating the optical signal in response to the receiving.

17. The method of claim 16, further comprising the event controller controlling operation of a seismic source.

18. The method of claim 16, further comprising the event controller controlling operation of a flow control device.

19. The method of claim 16, further comprising the event controller controlling operation of an explosive device.

20. The method of claim 16, wherein the modulating further comprises modulating an optical path length.

21. The method of claim 16, wherein the modulating further comprises variably attenuating the optical signal.

22. The method of claim 16, wherein the modulating further comprises varying a phase of the optical signal.

23. The method of claim 16, further comprising an optical waveguide transmitting the optical signal at least partially to an optical modulator controlled by the modulator controller.

24. The method of claim 23, wherein the optical waveguide comprises an optical sensor which senses vibration due to the initiation of the event.

25. The method of claim 23, wherein the optical waveguide comprises an optical sensor which senses temperature change due to the initiation of the event.

26. The system of claim 23, wherein the optical waveguide is connected to multiple sensors which sense at least one parameter characteristic of the event.

27. The method of claim 23, wherein the event controller controls operation of a seismic source, and wherein the optical waveguide senses vibration generated by the seismic source.

28. The method of claim 16, wherein multiple optical signals are modulated in response to the indication from the event controller that the event is initiated.

29. A system for synchronizing at least one optical signal with an initiation of a seismic event, the system comprising:
a controller which controls initiation of vibration from a seismic source; and
at least one optical modulator which modulates the optical signal in response to operation of the seismic source by the controller.

30. The system of claim 29, wherein the seismic source comprises an explosive device.

31. The system of claim 29, wherein the seismic source comprises an earth vibrator.

32. The system of claim 29, wherein the seismic source comprises a fracture.

33. The system of claim 29, wherein the optical modulator modulates an optical path length.

34. The system of claim 29, wherein the optical modulator variably attenuates the optical signal.

35. The system of claim 29, wherein the optical modulator varies a phase of the optical signal.

36. The system of claim 29, further comprising an optical waveguide which transmits the optical signal at least partially to the modulator.

37. The system of claim 36, wherein the optical waveguide comprises an optical sensor which senses vibration due to the operation of the seismic source.

38. The system of claim 36, wherein the optical waveguide comprises an optical sensor which senses temperature change due to the operation of the seismic source.

39. The system of claim 36, wherein the optical waveguide is connected to multiple sensors which sense at least one parameter characteristic of the seismic event.

40. The system of claim 36, wherein the optical waveguide senses vibration generated by the seismic source.

41. The system of claim 29, wherein multiple optical signals are modulated by respective multiple optical modulators in response to the operation of the seismic source by the controller.

42. A system for synchronizing multiple optical signals, the system comprising:
at least one time-code generator which generates time-codes; and
multiple optical modulators which modulate the respective optical signals in response to generation of the time-codes by the at least one time-code generator.

43. The system of claim 42, wherein the time-code generator comprises a Global Positioning System receiver.

44. The system of claim 43, wherein the optical modulators modulate the respective optical signals in response to generation of location information by the Global Positioning System receiver.

45. The system of claim 42, wherein the at least one time-code generator comprises multiple time-code generators, and the optical modulators modulate the respective optical signals in response to generation of the time-codes by respective ones of the time-code generators.

46. The system of claim 45, wherein the multiple time-code generators comprise multiple Global Positioning System receivers, and the optical modulators modulate the respective optical signals in response to generation of respective location information by the respective Global Positioning System receivers.

47. The system of claim 42, further comprising a controller which controls initiation of vibration from a seismic source, and wherein the controller is in communication with the at least one time-code generator.

48. The system of claim 42, further comprising multiple optical waveguides which transmit the respective optical signals at least partially to the respective modulators.

49. The system of claim 48, wherein the optical waveguides comprise optical sensors which sense vibration due to operation of a seismic source.

50. The system of claim 48, wherein the optical waveguides are connected to multiple sensors which sense at least one parameter characteristic of a seismic event.

51. A method of synchronizing multiple optical signals, the method comprising:
providing communication between multiple optical modulators and at least one time-code generator which generates time-codes; and
the optical modulators modulating the respective optical signals in response to generation of the time-codes by the at least one time-code generator.

52. The method of claim 51, wherein the time-code generator comprises a Global Positioning System receiver.

53. The method of claim 52, wherein the optical modulators modulate the respective optical signals in response to generation of location information by the Global Positioning System receiver.

54. The method of claim 51, wherein the at least one time-code generator comprises multiple time-code generators, and the optical modulators modulate the respective optical signals in response to generation of the time-codes by respective ones of the time-code generators.

55. The method of claim 54, wherein the multiple time-code generators comprise multiple Global Positioning System receivers, and the optical modulators modulate the respective optical signals in response to generation of respective location information by the respective Global Positioning System receivers.

56. The method of claim 51, further comprising a controller which controls initiation of vibration from a seismic source, and wherein the controller is in communication with the at least one time-code generator.

57. The method of claim 51, further comprising multiple optical waveguides which transmit the respective optical signals at least partially to the respective modulators.

58. The method of claim 57, wherein the optical waveguides comprise optical sensors which sense vibration due to operation of a seismic source.

59. The method of claim 57, wherein the optical waveguides are connected to multiple sensors which sense at least one parameter characteristic of a seismic event.
